(19) United States
(12) Patent Application Publication
(10) Pub. No.: US 2025/0270108 A1
(43) Pub. Date: Aug. 28, 2025

(54) METHODS FOR PRODUCING PALLADIUM NANOPARTICLES DECORATED TRANSITION METAL DICHALCOGENIDES AND USES THEREOF IN HYDROGEN EVOLUTION REACTIONS

(71) Applicant: CITY UNIVERSITY OF HONG KONG, Kowloon (HK)

(72) Inventors: Zhiyuan ZENG, Kowloon (HK); Liang MEI, Kowloon (HK)

(21) Appl. No.: 18/981,236

(22) Filed: Dec. 13, 2024

Related U.S. Application Data
(60) Provisional application No. 63/556,485, filed on Feb. 22, 2024.

(51) Int. Cl. C01G 41/00; B82Y 30/00; B82Y 40/00; C01G 23/00; C01G 39/06

(52) U.S. Cl. CPC C01G 41/00; C01G 23/007; C01G 39/06; B82Y 30/00; B82Y 40/00; C01P 2004/24

(57) ABSTRACT

Disclosed herein is a method for producing a palladium (Pd) decorated two-dimensional (2D) transition metal dichalcogenide (TMD) composite. The method includes steps of, (a) providing 2D TMD nanosheets; (b) dispersing the 2D TMD nanosheets in water to form a dispersion; (c) mixing the dispersion with palladium acetate to form a mixture; and (d) subjecting the mixture to sonication to deposit Pd nanoparticles on the 2D TMD nanosheets thereby forming the Pd decorated 2D TMD composite. Also disclosed herein is a method of producing hydrogen from an aqueous solution. The method includes electrolyzing the aqueous solution in an electrochemical cell characterizing in having an electrode made from the present Pd decorated 2D TMD composite.

### CROSS-REFERENCE TO RELATED APPLICATION

This application claims priority and the benefit of U.S. Provisional Patent Application No. 63/556,485, filed Feb. 22, 2024, the entirety of which is incorporated herein by reference.

### BACKGROUND OF THE INVENTION

### 1. Field of the Invention

The present invention relates to methods of producing electrodes comprising IT/IT′-phase transition metal dichalcogenide (TMD) nanosheets, and their uses in hydrogen evolution reaction (HER).

### 2. Description of Related Art

Due to energy scarcity, industry and researcher throughout the world are eager to develop an efficient and inexpensive electrocatalyst for producing clean energy (i.e., hydrogen) from the most abundant source on earth (i.e., water) via water splitting, or hydrogen evolution reaction (HER). Two-dimensional (2D) materials, particularly, 2D-transition metal dichalcogenides (2D-TMDs), have become an alternative electrocatalyst due to their high aspect ratios and ultrathin structures. A number of ways have been proposed to enhance the electrocatalytic activities of 2D-TMDs, including doping, formation of composites, introducing defects in the lattice, and etc. To date, forming composite of two or more materials has been regarded as the best way to enhance the electrocatalytic activities of 2D-TMDs. Not only does the formation of composite may address the limitation of individual material, but also can maximize the function of each material. Most importantly, the combination of materials may bring new function to the newly formed composite. However, current methods for forming TMD composites are either too stringent (e.g., require operation at high temperature) or un-environmentally friendly. Accordingly, there exists in the related art a need of an improved method for producing TMD composite in an easy-to-use and environmental friendly manner, and the TMD composite possesses high electrocatalytic activity, thus can serve as a catalyst for reducing hydrogen ions into hydrogen via HER.

### SUMMARY

Embodiments of the present disclosure relate to methods of producing palladium (Pd) nanoparticles decorated two-dimensional (2D) metal dichalcogenide (TMD) composites. The thus produced composites may be used in an electrochemical cell to produce hydrogen from an aqueous solution via hydrogen evolution reaction (HER).

The first objective of the present disclosure therefore aims to provide a method of producing Pd nanoparticles decorated 2D TMD composites. The method comprises:
(a) providing 2D TMD nanosheets;
(b) dispersing the 2D TMD nanosheets in water to form a dispersion;
(c) mixing the dispersion with palladium acetate to form a mixture; and
(d) subjecting the mixture to sonication to deposit Pd nanoparticles on the 2D TMD nanosheets thereby forming the Pd decorated 2D TMD composite; wherein,
each Pd nanoparticle grown on the 2D TMD nanosheets is about 0.8 nm to 1.4 nm in diameter.

According to embodiments of the present disclosure, the 2D TMD nanosheets are produced by,
(i) discharging a bulk TMD in a lithium battery to produce a lithiated bulk TMD; and
(ii) sonicating the lithiated bulk TMD in water to exfoliate the lithiated bulk TMD into the 2D TMD nanosheets;
wherein,
the lithium battery comprises:
   an anode made of a lithium foil;
   a cathode made of a copper foil having the bulk TMD coated thereon; and
   an electrolyte consisting of LiPF₆, ethyl carbonate (EC), dimethyl carbonate (DMC), and ethyl methyl carbonate (EMC).

According to embodiments of the present disclosure, in step (i), a constant current of 0.025-0.1 mA and a cutoff voltage of 0.9-0.7 V are applied to the lithium battery to discharge the bulk TMD.

According to embodiments of the present disclosure, the 2D TMD nanosheets are MoS₂ nanosheets, WS₂ nanosheets, or TiS₂ nanosheets. In some embodiments, the 2D TMD nanosheets are MoS₂ nanosheets. In other embodiments, the 2D TMD nanosheets are WS₂ nanosheets. In further embodiments, the 2D TMD nanosheets are TiS₂ nanosheets.

Accordingly, the second objective of the present disclosure aims at providing an electrochemical cell for HER. The electrochemical cell comprises in its structure, a working electrode produced by coating a substrate with an ink solution, and air-drying the ink solution coated substrate, wherein the ink solution is produced by,
(i) mixing the present Pd decorated 2D TMD composite and a solution to give a mixture, in which the solution consists of ethanol and 5% sulfonated polytetrafluoroethylene copolymer at a volume ratio of 25:1; and
(ii) sonicating the mixture to produce the ink solution;
a reference electrode;
a counter-electrode; and
an electrolyte consisting of 0.5 M sulfuric acid.

The third aspect of the present disclosure thus is directed to a method for producing hydrogen from an aqueous solution. The method comprises electrolyzing the aqueous solution in the present electrochemical cell.

According to embodiments of the present disclosure, the aqueous solution is water.

Other and further embodiments of the present disclosure are described in more detail below.

### BRIEF DESCRIPTION OF THE DRAWINGS

The disclosure will become more fully understood from the detailed description and the drawings given herein below for illustration only, and thus does not limit the disclosure, wherein:

FIG. 1 is a flowchart depicting a method 100 for producing 2D TMD nanosheets in accordance with one embodiment of the present disclosure; and

FIG. 2 is a flowchart depicting a method 200 for producing Pd decorated 2D TMD composites in accordance with one preferred embodiment of the present disclosure.

### DETAILED DESCRIPTION

Detailed descriptions and technical contents of the present disclosure are illustrated below in conjunction with the accompanying drawings. However, it is to be understood that the descriptions and the accompanying drawings disclosed herein are merely illustrative and exemplary and not intended to limit the scope of the present disclosure.

The term “electrocatalyst” as used herein refers to a catalyst that takes part in an electrochemical reaction in the form of a surface of an electrode or the electrode per se. Electrocatalyst may facilitate the transfer of electrons between an electrode and a reaction agent, and/or the intermediate reactions of half-reactions of the cell. Like other catalysts, the electrocatalyst may lower the activation energy level without changing the chemical equilibrium thereof.

The term “hydrogen evolution reaction (HER)” as used herein refers to the half reaction of electrochemical water splitting, in which hydrogen ions are reduced to hydrogen (i.e., 2H⁺+2e⁻→H₂), which is a key chemical agent and fuel. In general, the reduction of hydrogen ions into hydrogen requires the aid of a catalyst (e.g., Pd nanoparticles decorated TMD composites of the present disclosure).

### 1. Methods of Producing Pd Nanoparticles Decorated Transition Metal Dichalcogenide (TMD) Composites

The first objective of the present disclosure is directed to a method of producing Pd nanoparticles (NPs) decorated 2D TMD composites. The Pd NPs decorated 2D TMD composites are catalysts suitable for constructing electrodes of an electrochemical cell to generate hydrogen from an aqueous solution via hydrogen evolution reaction (HER).

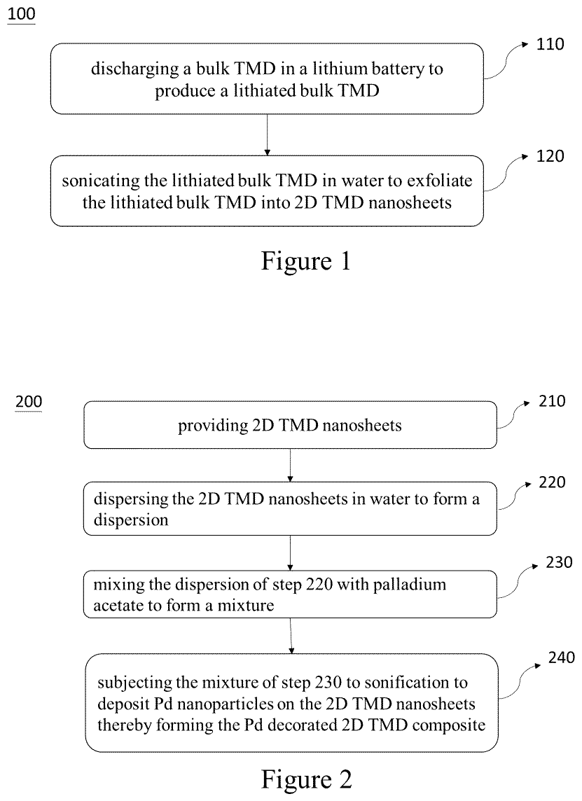

To produce the desired catalysts, 2D TMD nanosheets are first produced by electrochemical lithium intercalation followed by exfoliation in water, detail steps are described in the flowchart in FIG. 1. To this purpose, a lithium battery for performing the method 100 described in the flowchart is constructed. Specifically, a cathode (i.e., bulk TMD (MoS₂, WS₂ or TiS₂) coated copper foil) is assembled with an anode (i.e., a lithium foil), and an electrolyte (i.e., a mixture of LiPF₆, ethyl carbonate (EC), dimethyl carbonate (DMC), and dimethyl carbonate (DMC)) into the lithium battery, and a potential difference is applied to the battery to intercalate lithium ions into the cathode (FIG. 1, step 110). According to embodiments of the present disclosure, the lithium battery is discharged at a constant current of 0.025-0.1 mA and a cut off voltage of 0.9-0.7 V thereby producing a lithiated bulk TMD. The lithiated bulk TMD is then subjected to sonification in water so as to exfoliate the lithiated bulk TMD into 2D TMD nanosheets (FIG. 1, step 120). The thus produced 2D TMD nanosheets are subsequently collected via centrifugation.

According to embodiments of the present disclosure, the exfoliated 2D TMD nanosheets disperse very well in water, and this dispersion may be attributed to the negative charges on their surfaces. Further, each of the exfoliated 2D TMD nanosheet has smooth surface and a thickness of less than 1 nm. Examples of the 2D TMD nanosheets are suitable for use in the present disclosure include, but are not limited to, molybdenum disulfide (MoS₂) nanosheets, tungsten disulfide (WS₂) nanosheets, titanium disulfide (TiS₂) nanosheets, and etc. According to some embodiments of the present disclosure, the 2D TMD nanosheets are the suspension of MoS₂ nanosheets. According to other embodiments of the present disclosure, the 2D TMD nanosheets are the suspension of WS₂ nanosheets. According to further embodiments of the present disclosure, the 2D TMD nanosheets are the suspension of TiS₂ nanosheets.

The 2D TMD nanosheets (e.g., MoS₂, WS₂ or TiS₂ nanosheets) thus produced may then be used to fabricate the desired catalyst, detail steps are described in the flowchart in FIG. 2. To this purpose, 2D TMD nanosheets produced by the method 100 described above (FIG. 2, step 210) are re-dispersed in water to give the desired suspension of 2D TMD nanosheets (FIG. 2, step 220). The 2D TMD nanosheets dispersion is then mixed with palladium acetate to form a mixture (FIG. 2, step 230); the mixture is then subjected to sonification to deposit Pd NPs on the 2D TMD nanosheets thereby forming the Pd decorated 2D TMD composite (FIG. 2, step 240).

The thus produced Pd NPs decorated 2D TMD composites may be collected via centrifugation. According to embodiments of the present disclosure, each Pd nanoparticle grown on the 2D TMD nanosheets is about 0.8 nm to 1.4 nm in diameter, such as 0.8, 0.9, 1.0, 1.2, 1.3, or 1.4 nm in diameter. In some embodiments, each Pd NP grown on 2D MoS₂ nanosheets is about 0.81 nm in diameter. In other embodiments, each Pd NP grown on 2D WS₂ nanosheets is about 0.90 nm in diameter. In further embodiments, each Pd NP grown on 2D TiS₂ nanosheets is about 1.37 nm in diameter.

### 2. HER Performance of the Present Pd Decorated 2D TMD Composite

The afore-mentioned Pd decorated 2D TMD composite possesses higher electrochemical activity (i.e., Tafel slope) and may be used as electrocatalysts for generating hydrogen via HER. Accordingly, the second objective of the present disclosure is to provide an electrochemical cell for generating hydrogen from an aqueous solution. The electrochemical cell is characterized in having a working electrode (or a negative electrode) comprising Pd NPs decorated 2D TMD composite.

An electrochemical cell for HER is thus constructed. The cell comprises in its structure, a working electrode, a reference electrode, a counter electrode, and an electrolyte, which is 0.5 M sulfuric acid. According to embodiments of the present disclosure, the working electrode is produced by coating a substrate (e.g., carbon paper) with an ink solution; and air-drying the ink solution coated substrate. According to embodiments of the present disclosure, the ink solution is produced by, (i) mixing the present Pd decorated 2D TMD composite and a solution to give a mixture, in which the solution consists of ethanol and 5% sulfonated polytetrafluoroethylene copolymer at a volume ratio of 4:1; and (ii) sonicating the mixture to produce the ink solution. The working electrode may then be assembled with suitable reference electrode, counter electrode and electrolyte into the desired electrochemical cell. Any ordinary skilled person in the related art can choose suitable reference electrode, counter electrode and electrolyte for the assembly of the electrochemical cell without undue experimentation.

According to embodiments of the present disclosure, the electrocatalytic activity of the present Pd decorated 2D TMD composite is evaluated via measuring the changes of overpotential with current density in the electrochemical cell described above. Accordingly, a Tafel plot is produced and Tafel slope (mV/dec) is used as an indicator for the electrocatalytic activity. Note that Tafel slope is a measure of how the current density changes with overpotential, specifically, the number of mV required for increasing current density by 10 folds. Thus, the smaller the Tafel slope, the higher the electrocatalytic activity, as less overpotential is needed to reach higher current density. In some embodiments, after depositing the Pd NPs, the Tafel slope decreases from 101 mV/dec for MoS₂ to 43 mV/dec for Pd—MoS₂. In other embodiments, after deposition of Pd NPs, the Tafel slope decreases from 105 mV/dec for WS₂ to 49 mV/dec for Pd—WS₂. In further embodiments, the Tafel slope decreases from 97 mV/dec for TiS₂ to 61 mV/dec for Pd—TiS₂.

The third objective of the present disclosure thus is directed to a method for generating hydrogen. The method comprises electrolyzing an aqueous solution in the electrochemical cell described above.

According to embodiments of the present disclosure, the aqueous solution is water.

The present invention will now be described more specifically with reference to the following embodiments, which are provided for the purpose of demonstration rather than limitation. While they are typically of those that might be used, other procedures, methodologies, or techniques known to those skilled in the art may alternatively be used.

### EXAMPLES

### Material and Methods.

### Preparation of the 2D TMD Nanosheets

2D TMD (i.e., MoS₂, WS₂ or TiS₂) nanosheets were synthesized using a well-established procedure involving electrochemical lithium intercalation followed by exfoliation in water. In this process, the lithium intercalation step was carried out in a lithium-ion battery, with a lithium foil serving as the anode and bulk TMDs (MoS₂, WS₂ or TiS₂) coated copper foil acting as the cathode. The electrolyte used in this process consisted of a 1 M LiPF₆ solution dissolved in a mixture of ethyl carbonate (EC), dimethyl carbonate (DMC) and ethyl methyl carbonate (EMC) (in a 1:1:1 volume ratio). The battery was operated using galvanostatic discharge, with a constant current of 0.025-0.1 mA and a cutoff voltage of 0.9-0.7 V, facilitating the lithiation process. Subsequently, the lithiated TMDs (i.e., LiₓMoS₂, Liₓ WS₂, or LiₓTiS₂) sample obtained from the lithiation process was carefully extracted and subjected to sonication in DI water to exfoliate the bulk sample into 2D nanosheets. To ensure purity, the resulting nanosheets underwent centrifugation and were thoroughly washed with DI water to remove any residual lithium ions and any remaining electrolytes, as well as other potential contaminants.

### Synthesis of the Pd-TMD Composites

A 1 mL sample of prepared 2D TMD (MoS₂, WS₂ or TiS₂) nanosheets were individually dispersed in DI water at a concentration of approximately 40 mg/L. To each TMD nanosheet solution, 100 μL of a 0.8 mg/mL palladium acetate solution was added. The solution was sonicated for 30 min to ensure thorough mixing and interaction. The resulting mixture then underwent centrifugation at 9,000 rpm for 5 min. Subsequently, the supernatant was carefully removed. The collected precipitate was re-dispersed in DI water. This washing process was repeated three times to eliminate any residual reactants and impurities. The purified precipitate containing Pd-TMD composites was re-dispersed in DI water for subsequent characterization and electrode preparation.

### Material Characterization

A transmission electron microscope (TEM, JEM 2100F) equipped with an energy-dispersive X-ray spectroscopy (EDS) detector was utilized for the examination of morphology and elemental composition of the materials. The chemical state of the samples was characterized using X-ray photoelectron spectrometer (XPS, Thermo Fisher ESCALAB XI). The phase purity of the materials was confirmed by X-ray diffraction (XRD, D2 PHASER XE-T). Atomic vibration patterns were carried out by using Raman spectrometer (WITec alpha 300 confocal Raman microscope). The surface charge of TMD or composites was measured by Zeta potential (Malvern Zetasizer Nano series).

### Electrocatalytic Measurements

TMD and Pd-TMD composites were evaluated for their HER performance in a 0.5 M H₂SO₄ solution. The catalyst ink was prepared as follows: each sample was mixed with ethanol and 5% NAFION™ perfluorinated resin solution (or sulfonated polytetrafluoroethylene copolymer) (v/v=25:1), forming the electrode coating solution. The mixture was subjected to ultrasonication (30 min) to ensure uniform dispersion of the catalyst. Subsequently, 50 μL of the well-dispersed electrode coating solution was drop coated onto a 1.5×0.5 cm carbon paper electrode. The coated carbon paper electrode was air-dried at room temperature, creating the working electrode, which was then evaluated for its electrocatalytic property using a typical 3-electrode setup at room temperature. The setup included an Ag/AgCl electrode as the reference electrode, a graphite rod as the counter electrode. For the electrochemical testing, linear sweep voltammetry (LSV) was conducted at a scan rate of 2 mV/s, and cyclic voltammetry (CV) was performed at a scan rate of 100 mV/s.

### Example 1: Fabrication and Characterization of Pd-Decorated TMD Composites

### 1.1 Pd-Decorated TMD Composites

In this example, 2D MoS₂, WS₂ or TiS₂ nanosheets were produced by procedures involving electrochemical lithium intercalation followed by exfoliation in water in accordance with procedures described in the “Materials and methods” section. Briefly, a lithium-ion battery was constructed, and the battery was operated using galvanostatic discharge, with a constant current of 0.025-0.1 mA and a cutoff voltage of 0.7-0.9 V, facilitating the lithiation process. Then, the LiₓMoS₂, LiₓWS₂ or LiₓTiS₂ sample obtained from the lithiation process was carefully extracted and sonicated in distilled water to exfoliate the bulk sample into 2D nanosheets. To ensure purity, the resulted nanosheets underwent centrifugation and were thoroughly washed with distilled (DI) water to remove any residual lithium ions and any remaining electrolytes, as well as other potential contaminants. The layered structure of the bulk MoS₂, WS₂ or TiS₂ were clearly observed in their Scanning electron microscopy (SEM) images, and their high-purity phase was confirmed through XRD spectra analysis (data not shown).

The thus prepared 2D MoS₂, WS₂ or TiS₂ nanosheets were dispersed in water (40 mg/L), the dispersion was then mixed with palladium acetate (0.8 mg/L) and the mixture was sonicated for 30 min to ensure thorough mixing and interaction. The resulting products then underwent centrifugation (9,000 rpm, 5 min) to give the desired Pd nanoparticles decorated composites.

### 1.2 Structure and Morphological Characterization

TEM images confirmed that exfoliated MoS₂, WS₂ or TiS₂ nanosheets exhibited nanosheet morphology characterized by having a smooth surface and excellent crystallinity. TEM images of Pd-modified TMD composites (MoS₂, WS₂ or TiS₂ composites) revealed that there was dense loading of monodisperse Pd nanoparticles (NPs) onto the MoS₂, WS₂ or TiS₂ nanosheets. EDS mapping images further validated the homogeneous dispersion of Pd NPs on MoS₂, WS₂ or TiS₂ nanosheets. The average size of Pd NPs in Pd—MoS₂, Pd—WS₂, and Pd—TiS₂ determined from an analysis of 100 NPs, was found to be 0.81 nm, 0.90 nm, and 1.37 nm, respectively. These findings confirmed the successful fabrication of sub-nanometric Pd NPs on MoS₂, WS₂ or TiS₂ nanosheets. The XRD patterns exclusively exhibited the (002) peak for MoS₂ and WS₂, and (001) peak for TiS₂, respectively. Note that no discernible peaks corresponding to Pd NPs were found, further confirming the amorphous nature of Pd NPs formed on these TMD composites.

After growing Pd NPs on TMD nanosheets, all the Raman peaks of Pd-TMDs shifted to higher wavelengths compared to the pristine TMDs. This shift in each peak was attributed to the charge transfer between Pd NPs and TMDs. Additionally, the zeta potential results of Pd-TMDs showed that following the growth of Pd NPs, the zeta potential values of Pd—MoS₂, Pd—WS₂, and Pd—TiS₂ increased to −1.57 mV, −3.07 mV, and −2.36 mV, respectively. This decrease in negative charge on the TMD surface further supported the observed charge transfer from TMDs to Pd NPs after the reaction.

### Example 2 Electrochemical Properties of Pd-Decorated TMD Composites

The electrochemical properties of Pd decorated MoS₂/WS₂/TiS₂ composites of Example 1 were evaluated in 0.5M H₂SO₄ electrolyte using linear sweep voltammetry (LSV). Accordingly, the Pd-TMDs of Example 1 were fabricated into electrodes in accordance with procedures described in the “Materials and methods” section.

In comparison to pristine TND (MoS₂, WS₂, or TiS₂ nanosheets), all Pd-decorated composites exhibited enhanced activity, as evidenced by the decreased overpotentials at a current density of 10 mA/cm² in the polarization curves. This enhancement could be attributed to the synergistic coupling effect between TMDs nanosheets and Pd NPs. From the Tafel plots, it was evident that after depositing the Pd NPs, the Tafel slope decreased from 101 mV/dec for MoS₂ to 43 mV/dec for Pd—MoS₂. A similar enhancement in catalytic activity was also observed for Pd—WS₂ and Pd—TiS₂ composites, with the Tafel slope lowering from 105 mV/dec for WS₂ to 49 mV/dec for Pd—WS₂, and from 97 mV/dec for TiS₂ to 61 mV/dec for Pd—TiS₂. Electrochemical impedance spectroscopy (EIS) was also employed to assess the charge transfer resistance of Pd-TMDs, as well as the pristine TMD electrodes. Further, the radius of the semicircles in the high-frequency region of Nyquist plots reflects the charge-transfer resistance (R_{ct}), which signifies the resistance of charge transfer at the interface between the electrolyte and the electrode. All Pd-TMDs exhibited smaller charge transfer resistance compared to those of pristine TMDs (i.e., MoS₂, WS₂, or TiS₂) (data not shown). This further confirmed the efficient charge transfer kinetics of Pd-TMDs during the HER.

Cyclic stability is a crucial consideration for practical applications. Therefore, all Pd-TMD composites were tested to assess their stability. It was found that all Pd-TMD composites displayed long term stability with no obvious decline in the current density at an overpotential of 130 mV for over 10 hrs. After the HER stability test, the peak positions in XPS spectra for Pd, Mo, W, and Ti, as well as the characteristic peaks in Raman spectra for Pd-TMDs, exhibited negligible differences after the durability test, indicating their structural stability post-testing. Furthermore, SEM images of Pd-TMDs after HER stability test revealed no obvious changes in morphology, with the monodispersed Pd NPs remaining on the nanosheets without aggregation. Overall, Pd-TMD catalysts fabricated in this disclosure demonstrated excellent structural stability after the HER test.

Taken together, Pd-TMD composites developed in the present disclosure exhibited much better activity than most other catalysts, considering factors like Tafel slope and overpotential at a current density of 10 mA/cm². The superior performance can be attributed to the presence of Pd NPs and the amorphous Pd structure in these composites. Accordingly, the Pd-TMDs of the present disclosure hold promise as alternatives to commercial Pt—C catalysts for HER applications.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of the present disclosure.

What is claimed is:

1. A method of producing a palladium (Pd) decorated two-dimensional (2D) transition metal dichalcogenide (TMD) composite comprising:
(a) providing 2D TMD nanosheets;
(b) dispersing the 2D TMD nanosheets in water to form a dispersion;
(c) mixing the dispersion with palladium acetate to form a mixture; and
(d) subjecting the mixture to sonication to deposit Pd nanoparticles on the 2D TMD nanosheets thereby forming the Pd decorated 2D TMD composite;
wherein,
each Pd nanoparticle deposited on the 2D TMD nanosheets is about 0.8 nm to 1.4 nm in diameter.

2. The method of claim 1, wherein in step (a), the 2D TMD nanosheets are produced by,
(i) discharging a bulk TMD in a lithium battery to produce a lithiated bulk TMD; and
(ii) sonicating the lithiated bulk TMD in water to exfoliate the lithiated bulk TMD into the 2D TMD nanosheets;
wherein,
the lithium battery comprises:
an anode made of a lithium foil;
a cathode made of a copper foil having the bulk TMD coated thereon; and
an electrolyte consisting of LiPF₆, ethyl carbonate (EC), dimethyl carbonate (DMC), and ethyl methyl carbonate (EMC).

3. The method of claim 2, wherein in step (i), a constant current of 0.025-0.1 mA and a cutoff voltage of 0.7-0.9 V are applied to the lithium battery to discharge the bulk TMD.

4. The method of claim 1, wherein the 2D TMD nanosheets are MoS₂ nanosheets, WS₂ nanosheets, or TiS₂ nanosheets.

5. The method of claim 3, further comprising collecting the Pd decorated 2D TMD composites of step (d) by centrifugation.

6. A cell comprising:
a working electrode produced by coating a substrate with an ink solution, and air-drying the ink solution coated substrate, wherein the ink solution is produced by,
(i) mixing the Pd decorated 2D TMD composite produced by the method of claim 1 and a solution to give a mixture, in which the solution consists of ethanol and 5% sulfonated polytetrafluoroethylene copolymer at a volume ratio of 25:1; and
(ii) sonicating the mixture to produce the ink solution;
a reference electrode;
a counter-electrode; and
an electrolyte consisting of 0.5 M sulfuric acid.

7. A method for producing hydrogen from an aqueous solution comprising electrolyzing the aqueous solution in the cell of claim 6.

8. The method of claim 7, wherein the aqueous solution is water.
